(19) United States
(12) Patent Application Publication
(10) Pub. No.: US 2003/0227939 A1
(43) Pub. Date: Dec. 11, 2003

(54) Establishing a connection using a hybrid receiver

(76) Inventors: Satoru Yukie, San Diego, CA (US); Mike Kwon, San Diego, CA (US); Duk San Kim, San Diego, CA (US); Kazuhiko Shirai, San Diego, CA (US)

Correspondence Address: FROMMER LAWRENCE & HAUG, 745 FIFTH AVENUE- 10TH FL., NEW YORK, NY, 10151, US

(21) Appl. No.: 10/456,872

(22) Filed: Jun. 5, 2003

Related U.S. Application Data
(60) Provisional application No. 60/386,348, filed on Jun. 5, 2002.
(60) Provisional application No. 60/463,298, filed on Apr. 16, 2003.

(51) Int. Cl. H04J 3/22

(52) U.S. Cl. 370/465; 370/395.5

(57) ABSTRACT

Methods and apparatus for establishing a connection to a hybrid receiver. In one implementation, a hybrid wireless handset includes: a radio interface including an antenna; a wireless telephony modem connected to said radio interface; a wireless IP modem connected to said wireless telephony modem and to said radio interface; an audio interface connected to said wireless telephony modem and to said wireless IP modem; and a user interface connected to said wireless telephony modem and to said wireless IP modem; wherein when said wireless telephony modem receives a connection notification from a first communication network, said wireless IP modem sends a connection reply to a second communication network.

This application claims the benefit of U.S. Provisional Application No. 60/386,348 filed Jun. 5, 2002, and U.S. Provisional Application No. 60/463,298 filed Apr. 16, 2003, the disclosures of which are incorporated herein by reference.

### BACKGROUND

Wireless receivers include cellular telephone handsets, such as CDMA PCS phones and GSM PCS phones. Another type of wireless receiver is a wireless local area network (WLAN) receiver or a wireless IP receiver, such as a wireless network modem operating according to IEEE 802.11 (i.e., the 802.11 standard published by IEEE; also known as “Wi-Fi”).

For a wireless and portable handset, battery life can be an important factor in design. A larger or more expensive battery can provide improved battery life. Alternatively, reducing power consumption can also improve battery life. Affecting power consumption while in standby mode (e.g., while the handset is powered on, monitoring signals from a network and providing status information to the network while waiting for a call to be place or received) can be one way of controlling battery life. In some cases, power consumption in standby mode using a WLAN modem is higher than power consumption in standby mode using a wireless telephony modem (e.g., a CDMA modem).

### SUMMARY

The present invention provides methods and apparatus for establishing a connection to a hybrid receiver. In one implementation, a hybrid wireless handset includes: a radio interface including an antenna; a wireless telephony modem connected to said radio interface; a wireless IP modem connected to said wireless telephony modem and to said radio interface; an audio interface connected to said wireless telephony modem and to said wireless IP modem; and a user interface connected to said wireless telephony modem and to said wireless IP modem; wherein when said wireless telephony modem receives a connection notification from a first communication network, said wireless IP modem sends a connection reply to a second communication network.

In one implementation, a method of establishing a connection to a hybrid receiver includes: sending a connection request to a first communication network according to a first communication protocol, wherein the connection request includes sender address information to establish a connection using a second communication protocol; and receiving a connection reply from a second communication network according to the second communication protocol and the sender address information.

In another implementation, a method of establishing a connection to a hybrid receiver includes: receiving a connection notification from a first communication network according to a first communication protocol, wherein the connection notification includes sender address information to establish a connection using a second communication protocol; and sending a connection reply to a second communication network according to the second communication protocol and the sender address information.

### BRIEF DESCRIPTION OF THE DRAWINGS

FIG. 1 shows a representation of one implementation of a network environment.

FIG. 2 is a representation of one implementation of a hybrid wireless handset.

FIG. 3 is a representation of another implementation of a hybrid wireless handset.

FIG. 4 shows a flowchart of one implementation of establishing a connection with a wireless receiver.

FIG. 5 shows a flowchart of one implementation of establishing a Wi-Fi connection with a wireless receiver using a CDMA network for notification.

FIG. 6 shows a flowchart of one implementation of establishing a connection with a wireless receiver using a text message for notification.

FIG. 7 shows a flowchart of one implementation of establishing a connection with a wireless receiver using a circuit switched voice call request for notification.

FIG. 8 shows a flowchart of one implementation of establishing a connection with a wireless receiver where the notification is built by the caller.

### DETAILED DESCRIPTION

The present invention provides methods and apparatus for establishing a connection to a hybrid receiver. In one implementation, the hybrid receiver is a hybrid wireless receiver supporting wireless communication using two wireless systems and protocols. The receiver receives a notification from a caller through the first wireless system and establishes a connection to the caller using the second wireless system. As a result, the hybrid receiver can be in standby mode using the first wireless system and then establish a connection in the second wireless system. This configuration can be desirable in an environment where the power consumption in standby mode supporting the first wireless system is lower than the power consumption in standby mode supporting the second wireless system.

In one example, in one implementation, a user at a computer system connected to an IP network places a voice over IP (“VoIP”) call to a hybrid wireless handset. The hybrid wireless handset supports both CDMA PCS and IEEE 802.11 (“Wi-Fi”; e.g., referring to a type of 802.11 interface, such as 802.11a, b, or g). In this example, the user at the computer system does not know the IP address of the hybrid wireless handset but does know the telephone number of the hybrid wireless handset. The user provides the computer system with the telephone number in the VoIP request. The computer system forwards the VoIP request to a server through the IP network. The server builds a notification or alert message for the hybrid wireless handset. The notification is a text message (e.g., using SMS or some other text messaging protocol). The text message includes: a special key word or sequence to notify the hybrid wireless handset that information to establish a VoIP call is included in the message; addressing for the VoIP call back to enable the hybrid wireless handset to access the server; and any other information necessary or useful for establishing the VoIP session between the computer system and the hybrid wireless handset (e.g., special routing information, traffic channel (payload) codec options, etc.). The server sends the notification to the hybrid wireless handset through the telephone network using the telephone number provided by the user. In one implementation, if the user provided the computer system with the IP address of the hybrid wireless handset instead of the telephone number, the server would request the telephone number for the hybrid wireless handset from the telephone network to send the notification.

The telephone network sends the notification to the hybrid wireless handset through a wireless CDMA PCS connection. The hybrid wireless handset checks the message for the special alert key and recognizes that the text message is a notification. The hybrid wireless handset extracts the address information from the text message. The hybrid wireless handset sends a reply to the server through a wireless Wi-Fi connection to the IP network. The reply includes the IP address of the hybrid wireless handset. The server facilitates establishing the connection between the computer system and the hybrid wireless handset and the computer system opens a VoIP session.

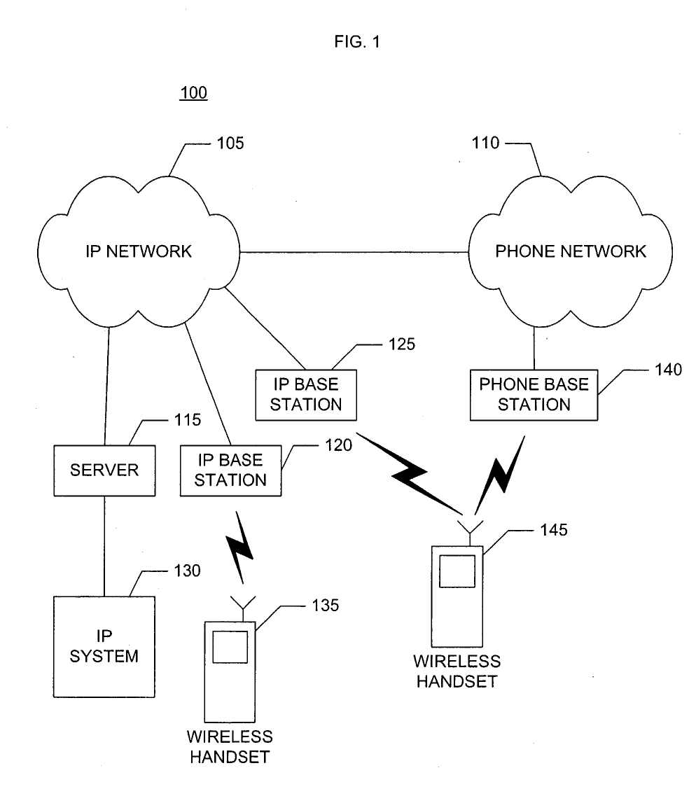

FIG. 1 shows a representation of one implementation of a network environment 100. An IP network 105 is connected to a phone network 110. The IP network 105 is a network operating according to the Internet Protocol (“IP”) and includes the Internet and one or more wireless IP networks, including one or more connected network devices (e.g., computer systems; not shown). In an alternative implementation, the IP network 105 includes one or more local or wide area networks in addition to or instead of the Internet. As shown in FIG. 1, a server 115, and two wireless IP base stations 120, 125 are connected to the IP network 105. An IP system 130, such as an IP-enabled computer system, is connected to the server 115. The IP base stations 120, 125 support a wireless network in the IP network 105, such as a Wi-Fi network. In an alternative implementation, the IP base stations 120, 125 are parts of different wireless networks. A wireless handset 135 can establish a wireless connection to IP base station 120. The wireless handset 135 supports IP communication according to the wireless network protocol corresponding to the connected IP base station 120. The wireless handset 135 can also connect to IP base station 125 if the wireless handset and the IP base station 125 support the same protocol.

The phone network 110 is a telephony based network and includes the public switched telephone network (PSTN) and one or more wireless telephone networks (e.g., a cellular phone network supporting CDMA), including one or more connected telephones (not shown). A phone base station 140 is connected to the phone network 110. The phone base station 140 supports a wireless phone network in the phone network 110, such as a CDMA network.

A hybrid wireless handset supports two type of wireless communication: using a wireless phone connection or using a wireless IP connection. The hybrid wireless handset 145 can establish a wireless phone connection to the phone base station 140. The hybrid wireless handset 145 can also establish a wireless IP connection to the IP base station 125. The wireless handset 145 supports IP communication according to the wireless network protocol corresponding to the connected IP base station 125. The wireless handset 145 can also connect to IP base station 120 if the wireless handset and the IP base station 120 support the same protocol.

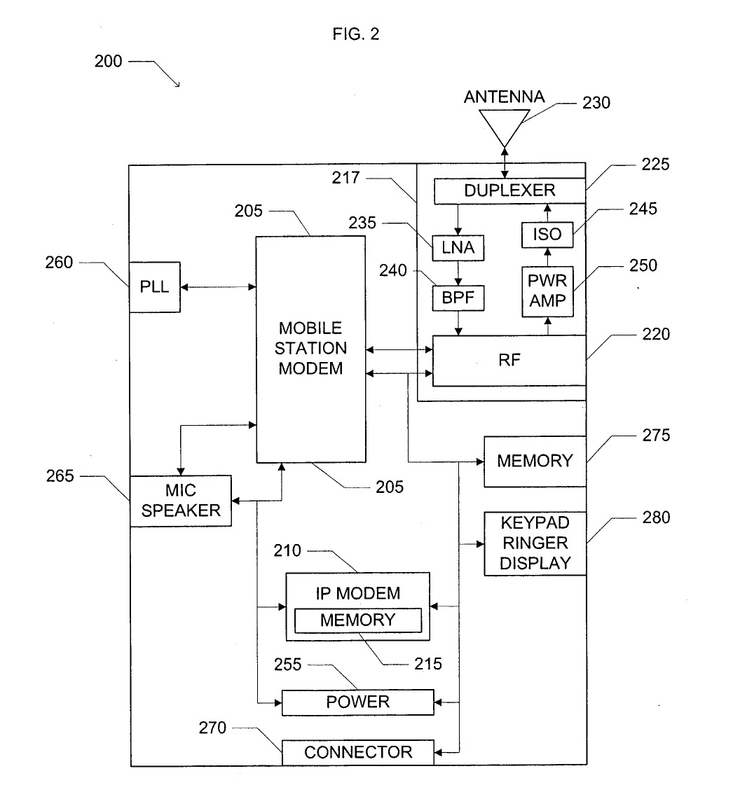

FIG. 2 is a representation of one implementation of a hybrid wireless handset 200, such as for the hybrid wireless handset 145 in FIG. 1. The hybrid wireless handset 200 includes a mobile station modem (“MSM”) 205 and an IP modem 210. The MSM 205 is a wireless telephony modem and supports a wireless phone connection and protocol or air interface, such as CDMA, TDMA, or GSM, among others. The MSM 205 also controls the general operation and user interface of the hybrid wireless handset 200. The IP modem 210 supports a wireless IP or network connection and protocol or interface, such as Wi-Fi or some other WLAN interface. The IP modem 210 includes a memory 215.

The hybrid wireless handset 200 includes a radio interface 217 including several components. The MSM 205 and the IP modem 210 share the same radio interface 217. The MSM 205 controls the operation of the components of the hybrid wireless handset 200 to support using either the MSM 205 or the IP modem 210 for providing a wireless connection. In one implementation, the radio interface 217 is a typical radio interface and includes: a radio frequency (“RF”) block 220, a duplexer 225, an antenna 230, a low noise amplifier (“LNA”) 235, a bandpass filter (“BPF”) 240, an isolator (“ISO”) 245, and a power amplifier (“PWR AMP”) 250. The radio interface 217 operates similarly to typical radio interfaces in wireless handsets. For sending signals, the RF block 220 is connected to the MSM 205 and to the IP modem, and provides modulated signals from the MSM 205 or the IP modem 210 to the power amplifier 250. The power amplifier 250 provides an amplified signal to the isolator 245, which in turn provides the signal to the duplexer 225 and on to the antenna 230. For receiving signals, the antenna 230 provides a received signal to the duplexer 225 which provides the signal to the LNA 235. The LNA 235 provides the amplified signal to the BPF 240, and the BPF 240 provides the filtered signal to the RF block 220. The RF block 220 provides the signal to the MSM 205 or IP modem 210 depending on the operating mode of the hybrid wireless handset 200 according to a control signal received from the MSM 205. In another implementation, the RF block 220 uses information in the signal to determine to which destination modem to send the signal.

The hybrid wireless handset 200 also includes additional components typical of wireless handsets to support the operation of the handset: a power source 255 (e.g., a battery); a phase locked loop (“PLL”) 260; an audio block 265 including a microphone and a speaker; an external connection interface or connector 270 (e.g., for a peripheral device or external power source); a memory 275; and a user interface block 280 including a keypad, ringer, and display. The MSM 205, IP modem 210, power source 255, and audio block 265 are interconnected. The MSM 205, IP modem 210, RF block 220, power source 265, connector 270, memory 275, and user interface block 280 are interconnected. The PLL 260 is connected to the MSM 205.

The hybrid wireless handset 200 supports a single interface standby mode. In standby mode, the MSM 205 monitors signals received by the radio interface 217 and sends status information through the radio interface to a wireless network according to the air interface of the MSM 205. While in standby mode, the hybrid wireless handset 200 does not use the IP modem 210 or send status information using the wireless interface of the IP modem 210. As described below, to establish a connection using the wireless interface of the IP modem 210, a caller first causes a notification to be sent to the hybrid wireless handset 200 using the air interface of the MSM 205. Accordingly, while the hybrid wireless handset 200 supports two wireless interfaces (the air interface of the MSM 205 and the wireless interface of the IP modem 210), the hybrid wireless handset 200 uses one standby mode to wait for and receive incoming calls or requests for communication. In another implementation, the hybrid wireless handset 200 supports multiple standby modes from which a user can select, including the single interface standby mode.

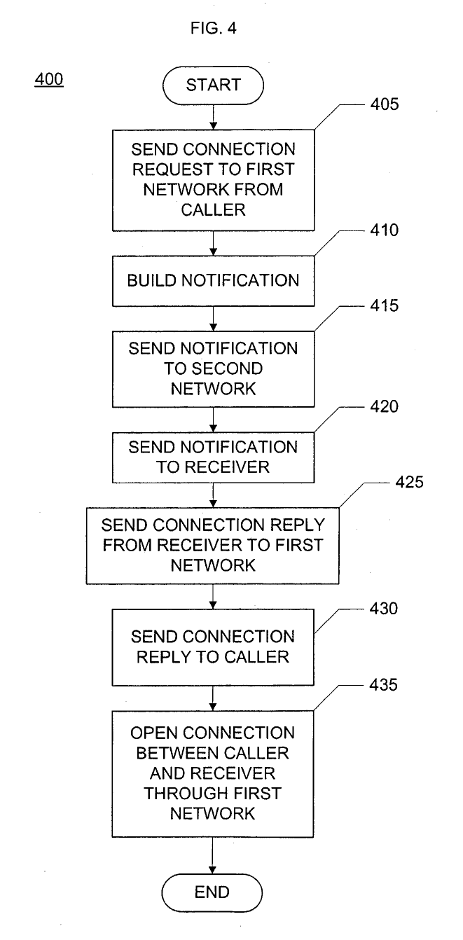

The MSM 205 also supports processing notifications of requests to establish connections using the IP modem 210. In different implementations, the hybrid wireless handset 200 receives different types of notifications. In one implementation, the notifications are text messages, such as messages sent using SMS (short message service). In another implementation, the notifications are circuit switched voice call requests including special information. In another implementation, the notifications are sent using end to end packet mode data connections. The MSM 205 checks incoming signals according to the type of notifications being used to determine if a notification has been received. When a notification is detected, the MSM 205 performs processing to facilitate establishing a wireless connection with the calling system identified in the notification using the IP modem 210, as described below referring to FIGS. 4-7.

In an alternative implementation, a hybrid wireless handset uses the IP modem 210 for standby mode. In this case, the hybrid wireless handset 200 receives notifications using the IP modem 210 and then establishes a connection with a caller using the MSM 205 according to the air interface of the MSM 205.

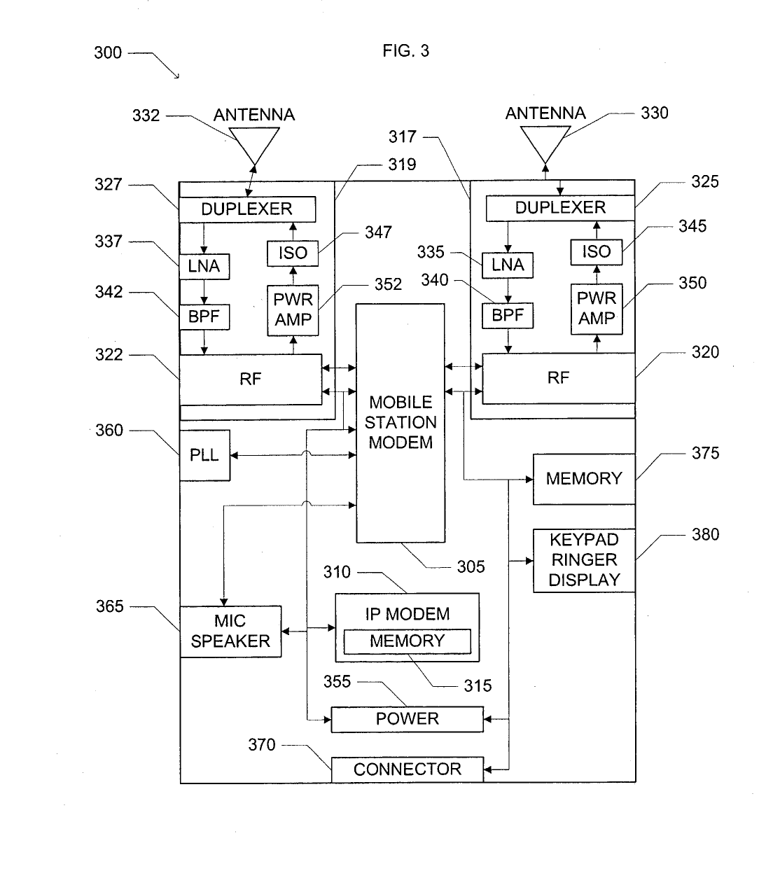

FIG. 3 is a representation of another implementation of a hybrid wireless handset 300, such as for the hybrid wireless handset 145 in FIG. 1. The hybrid wireless handset 300 in FIG. 3 is similar to the hybrid wireless handset 200 in FIG. 2, and similar components are numbered in a similar fashion (e.g., the MSM is numbered 205 in FIG. 2 and is numbered 305 in FIG. 3). However, in FIG. 3, the hybrid wireless handset 300 includes two radio interfaces 317 and 319. The MSM 305 and the IP modem 310 use different radio interfaces. The MSM 305 uses one radio interface 317 for wireless phone connections and the IP modem 310 uses the other radio interface 319 for wireless IP connections. Otherwise, the MSM 305, IP modem 310, radio interfaces 317, 319, and other components operate similarly to the components described above referring to FIG. 2.

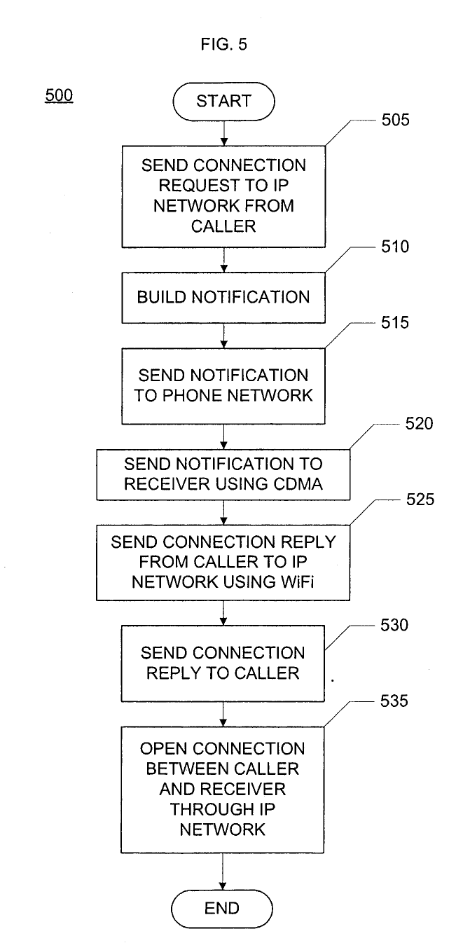

FIG. 4 shows a flowchart 400 of one implementation of establishing a connection with a wireless receiver. A caller system (the “caller”) and a recipient system (the “recipient”) are connected to two networks. The first and the second networks use respective network protocols, and both networks can be accessed through wireless connections. The caller is connected to the first network, either by wire or by a wireless connection. The recipient is a hybrid wireless handset (or other hybrid wireless system) connected to the second network in standby mode by a wireless connection, and can connect by wireless connection to the first network. Referring to FIG. 1, the caller can be the IP system 130 connected to the IP network 105 through the server 115, or the wireless handset 135 connected to the IP network 105 through the IP base station 120. The recipient can be the hybrid wireless handset 145 connected to phone network 110 through the phone base station 140, and having an available connection to the IP network 105 through the IP base station 125. An example of operation referring to the system shown in FIG. 1 is described below referring to FIG. 5.

The caller sends a connection request to a first network, block 405. The connection request is a request to establish a connection between the caller and a recipient through the first network. The connection request includes information identifying the recipient, such as a telephone number or an IP address. The connection request includes information identifying the caller, such as an IP address.

The first network builds a notification, block 410. In one implementation, the first network includes a connection server for facilitating connections between systems connected to the first network and hybrid wireless recipients. In one implementation, the connection server is a gateway between the first network and the second network. The connection server receives the connection request from the caller and builds a notification according to the request. The notification is configured to be sent to the recipient through the second network and includes the identifying information from the request. The notification also includes alert information indicating to the recipient that the caller has requested a connection with the recipient be established through the first network.

The first network sends the notification to the second network, block 415, and the second network sends the notification to the recipient, block 420. The notification includes information identifying the recipient, and the second network uses the information to route the notification through the second network and establish a wireless connection to the recipient. The second network sends the notification to the recipient through the wireless connection.

The recipient processes the notification and sends a connection reply to the first network, block 425. The recipient receives the notification from the second network and recognizes that the notification indicates a connection request has been placed by the caller in the first network. The recipient builds a connection reply using the identifying information from the notification and provides any needed identifying information in the connection request. The recipient opens a wireless connection to the first network and sends the connection reply to the first network through the wireless connection.

The first network sends the connection reply to the caller, block 430, and the caller opens a connection to the recipient through the first network, block 435. The connection server in the first network receives the connection reply and provides the connection reply to the caller. The caller receives the connection reply and extracts any needed information to open a connection to the recipient through the first network.

The connection between the caller and the first network and the connection between the first network and the second network are not necessarily the same type of connection. For example, the caller may use a wire connection while the recipient uses a wireless connection.

In one implementation, the caller opens a new connection through the first network to the recipient using the identifying information from the reply, and in another implementation, the caller uses the connection opened by the recipient to provide the reply to the first network. Similarly, in one implementation, the caller opens the connection to the recipient using the connection server, and in another implementation, the caller does not use the connection server. In another implementation, the connection server opens and maintains the connection between the caller and recipient after receiving confirmation that both parties are ready (e.g., after receiving the connection reply from the recipient and receiving a confirmation from the caller that the connection reply has been received and processed).

If the first network (e.g., the connection server) does not receive any confirmation or connection reply indicating that the recipient has received the notification or that the recipient will establish a connection to the first network, the first network attempts to establish an alternative connection. For example, the connection server uses a call-forwarding feature of the second network to facilitate a connection between the caller and the recipient through a combination of the first network and the second network (e.g., caller to first network to second network to recipient).

In an alternative implementation, before building the notification, the first network checks whether the recipient is connected to the first network already or is actively monitoring the first network. In this case, if the first network determines that the recipient is already available, the first network establishes a connection between the caller and recipient immediately, without using a notification sent through the second network as described above.

In another alternative implementation, the caller is connected indirectly to the first network, such as through the second network, or through a third network. For example, a user places a telephone call from a standard telephone through the PSTN (the second network) to the hybrid wireless handset and for some reason (e.g., routing) the call is routed to an IP network (the first network) to be handled by a VoIP server as a VoIP request. In this example, the caller is connected to the first network (the IP network) through the second network (the phone network). Eventually, the caller would be connected to the recipient through the second network to the first network and back to the second network.

FIGS. 5-7 show alternative implementations of establishing a connection to a receiver.

FIG. 5 shows a flowchart 500 of one implementation of establishing a Wi-Fi connection with a wireless receiver using a CDMA network for notification. The operation of this implementation is similar to that described above referring to FIG. 4. This implementation is described below referring to FIG. 1 as an example.

The caller is the IP system 130 connected to the IP network 105 through the server 115. The recipient is the hybrid wireless handset 145 connected to phone network 110 through the phone base station 140, and having an available connection to the IP network 105 through the IP base station 125.

The IP system 130 sends a connection request for a VoIP session with the hybrid wireless handset 145 to the IP network 105, block 505. As discussed above, the connection request includes information identifying the hybrid wireless handset 145, such as a telephone number, and includes information identifying the IP system 130, such as an IP address. In another implementation or other applications of the same implementation, the request is not for VoIP session, but instead is a request for some other data communication between the caller and the recipient. The server 115 builds a notification, block 510. The notification includes address information to establish a VoIP session with the caller (e.g., to enable the hybrid wireless handset 145 to contact the IP system 130). The server 115 sends the notification to the phone network 110 through the IP network 105, block 515. The phone network 110 sends the notification to the hybrid wireless handset 145 through the phone base station 140 using a CDMA connection, block 520. The hybrid wireless handset 145 extracts the address information from the notification and builds a connection reply, including address information so the IP system 130 can establish a connection to the hybrid wireless handset 145. The hybrid wireless handset 145 opens a Wi-Fi connection to the IP base station 125 and sends the connection reply to the IP network 105 through the IP base station 125, block 525. The IP network 105 sends the connection reply to the IP system 130, block 530. The IP system 130 receives the connection reply from the server 115 and establishes a connection to the hybrid wireless handset 145 through the IP network 105, block 535. The IP system 130 and the hybrid wireless handset 145 are now connected through the IP network 105 (the IP system 130 has a wire connection to the IP network 105 through server 115, and the hybrid wireless handset 145 has a Wi-Fi connection to the IP network 105 through IP base station 125).

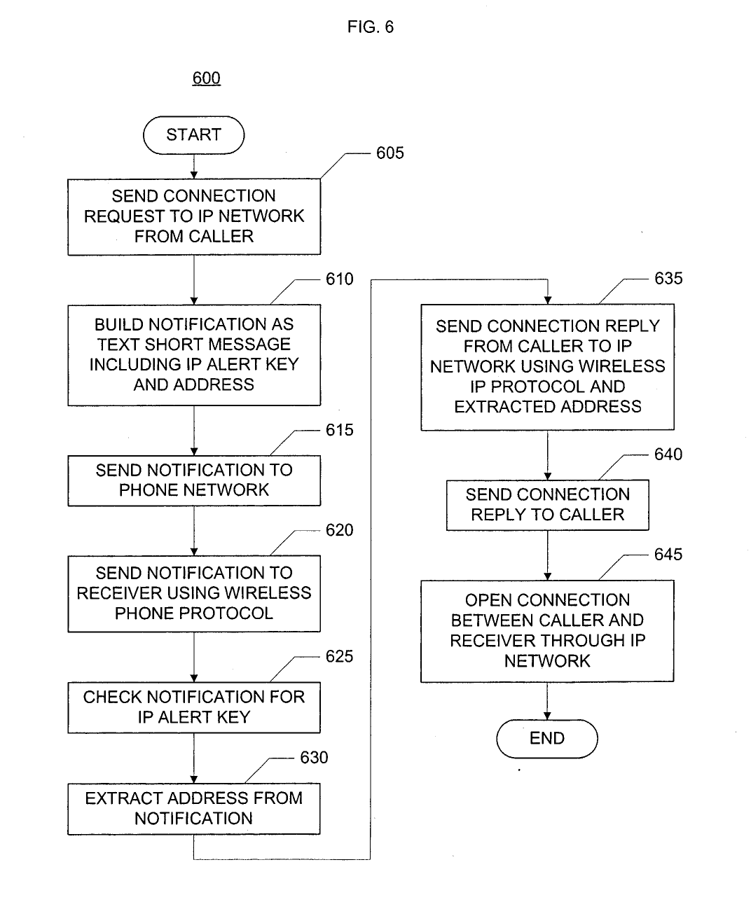

FIG. 6 shows a flowchart 600 of one implementation of establishing a connection with a wireless receiver using a text message for notification. The operation of this implementation is similar to that described above referring to FIG. 4. This implementation is described below referring to FIG. 1 as an example.

The caller is the IP system 130 connected to the IP network 105 through the server 115. The recipient is the hybrid wireless handset 145 connected to phone network 110 through the phone base station 140, and having an available connection to the IP network 105 through the IP base station 125.

The IP system 130 sends a connection request for a VoIP session with the hybrid wireless handset 145 to the IP network 105, block 605. As discussed above, the connection request includes information identifying the hybrid wireless handset 145, such as a telephone number, and includes information identifying the IP system 130, such as an IP address. As discussed above, the request need not be for a VoIP session.

The server 115 builds a notification as a text message, block 610. The text message is a text message compatible with the wireless phone network and air interface of the hybrid wireless handset 145 (e.g., using a text short message or a SMS message). The notification includes an alert key and address information to establish a connection with the caller (e.g., to enable the hybrid wireless handset 145 to contact the IP system 130). The alert key indicates that the text message is not an ordinary text message and that the recipient is to perform appropriate processing to respond. In another implementation, the text message also includes additional information to assist in establishing the connection between the IP system 130 and the hybrid wireless handset 145, such as special routing information.

The server 115 sends the text message notification to the phone network 110 through the IP network 105, block 615. The phone network 110 sends the text message notification to the hybrid wireless handset 145 through the phone base station 140 using a wireless phone connection, block 620. The phone network treats the text message notification as an ordinary text message.

The hybrid wireless handset 145 checks the text message for an alert key, block 625. After finding an alert key in the text message, the hybrid wireless handset 145 extracts the address information from the notification, block 630. The hybrid wireless handset 145 builds a connection reply, including address information so the IP system 130 can establish a wireless IP connection to the hybrid wireless handset 145. The hybrid wireless handset 145 opens a wireless IP connection to the IP base station 125 and sends the connection reply to the IP network 105 through the IP base station 125, block 635. The IP network 105 sends the connection reply to the IP system 130, block 640. The IP system 130 receives the connection reply from the server 115 and establishes a connection to the hybrid wireless handset 145 through the IP network 105, block 645. The IP system 130 and the hybrid wireless handset 145 are now connected through the IP network 105 (the IP system 130 has a wire connection to the IP network 105 through server 115, and the hybrid wireless handset 145 has a wireless IP connection to the IP network 105 through IP base station 125).

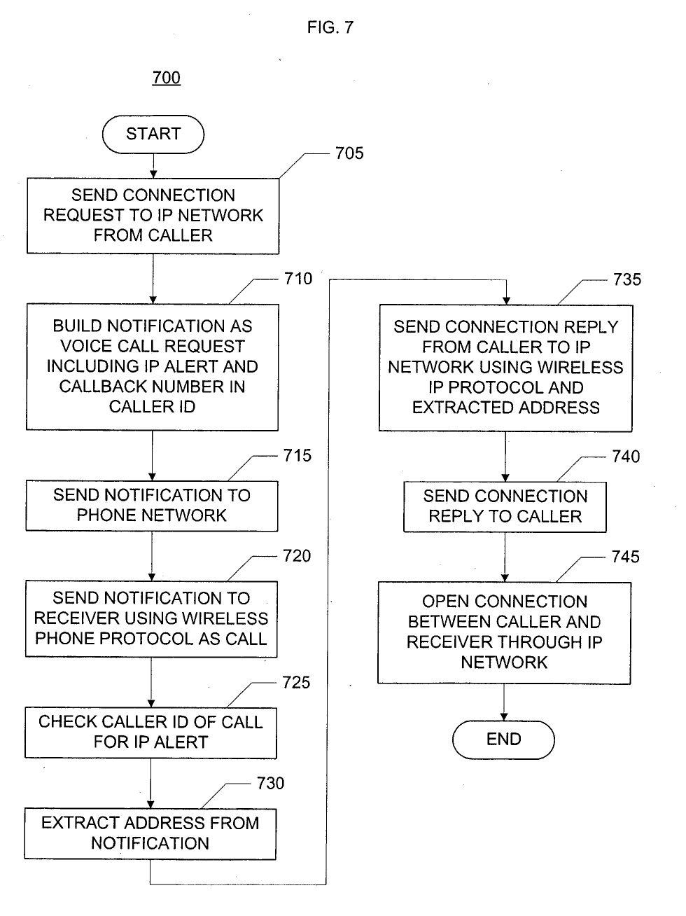

FIG. 7 shows a flowchart 700 of one implementation of establishing a connection with a wireless receiver using a circuit switched voice call request for notification. The operation of this implementation is similar to that described above referring to FIG. 4. This implementation is described below referring to FIG. 1 as an example.

The caller is the IP system 130 connected to the IP network 105 through the server 115. The recipient is the hybrid wireless handset 145 connected to phone network 110 through the phone base station 140, and having an available connection to the IP network 105 through the IP base station 125.

The IP system 130 sends a connection request for a VoIP session with the hybrid wireless handset 145 to the IP network 105, block 705. As discussed above, the connection request includes information identifying the hybrid wireless handset 145, such as a telephone number, and includes information identifying the IP system 130, such as an IP address. As discussed above, the request need not be for a VoIP session.

The server 115 builds a notification as a circuit switched voice call request, block 710. The notification includes an alert key and address information to establish a connection with the caller (e.g., to enable the hybrid wireless handset 145 to contact the IP system 130). The alert key indicates that the voice call request is not an ordinary voice call request and that the recipient is to perform appropriate processing to respond. In another implementation, the voice call request also includes additional information to assist in establishing the connection between the IP system 130 and the hybrid wireless handset 145, such as special routing information. In one implementation, the voice call request includes a call back phone number indicating the server 115, serving as the alert key and the address information. In another implementation, the alert key and address information is included in the caller ID information of the voice call request.

The server 115 sends the voice call request notification to the phone network 110 through the IP network 105, block 715. The phone network 110 sends the voice call request notification to the hybrid wireless handset 145 through the phone base station 140 using a wireless phone connection, block 720. The phone network treats the voice call request notification as an ordinary circuit switched voice call request for the recipient.

The hybrid wireless handset 145 checks the voice call request for an alert key, block 725. After finding an alert key in the text message, the hybrid wireless handset 145 extracts the address information from the notification, block 730. In an implementation where the voice call request includes a call back number for the server 115 in the caller ID information of the request, the hybrid wireless handset 145 recognizes the phone number as an alert and uses the phone number or other information in voice call request to build an IP address to connect to the server 115. Alternatively, the hybrid wireless handset 145 makes a connection to the server 115 through the phone network 110 using the call back phone number and retrieves or provides IP addressing information to establish a connection through the IP network 105.

The hybrid wireless handset 145 builds a connection reply, including address information so the IP system 130 can establish a wireless IP connection to the hybrid wireless handset 145. The hybrid wireless handset 145 opens a wireless IP connection to the IP base station 125 and sends the connection reply to the IP network 105 through the IP base station 125, block 735. The IP network 105 sends the connection reply to the IP system 130, block 740. The IP system 130 receives the connection reply from the server 115 and establishes a connection to the hybrid wireless handset 145 through the IP network 105, block 745. The IP system 130 and the hybrid wireless handset 145 are now connected through the IP network 105 (the IP system 130 has a wire connection to the IP network 105 through server 115, and the hybrid wireless handset 145 has a wireless IP connection to the IP network 105 through IP base station 125).

If the hybrid wireless handset 145 does not identify the voice call request notification as a notification or does not properly extract the information to build a connection reply, the hybrid wireless handset 145 responds to the voice call request as an ordinary voice call request. In one implementation, when the hybrid wireless handset 145 responds to the voice call request notification as an ordinary voice call request, the server 115 attempts to establish a call-forwarded connection between the IP system 130 and the hybrid wireless handset 145 (e.g., connecting the IP system 130 and the hybrid wireless handset 145 through both the IP network 105 and the phone network 110).

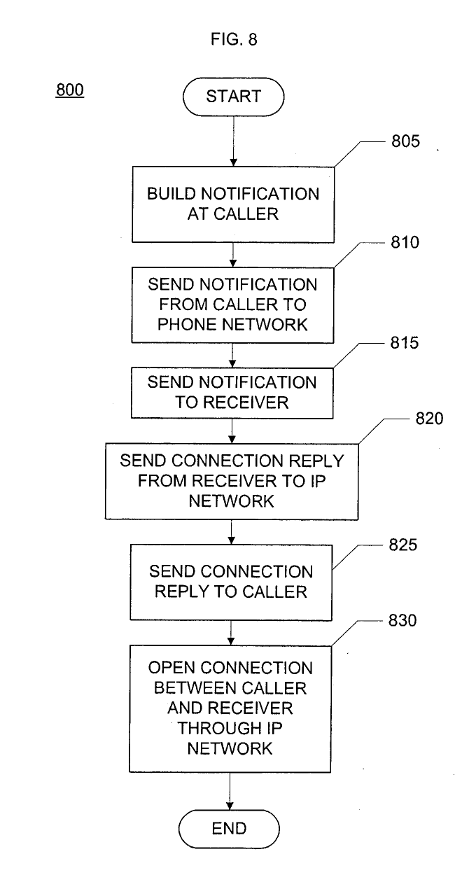

FIG. 8 shows a flowchart 800 of one implementation of establishing a connection with a wireless receiver where the notification is built by the caller. This implementation is different from that discussed above referring to FIG. 4 because the notification is built by the caller rather than the first network, as in FIG. 4. Otherwise, the operation of this implementation is similar to that described above referring to FIG. 4. This implementation is described below referring to FIG. 1 as an example.

The caller is the IP system 130 connected to the IP network 105 through the server 115. The recipient is the hybrid wireless handset 145 connected to phone network 110 through the phone base station 140, and having an available connection to the IP network 105 through the IP base station 125.

The IP system 130 builds a notification, block 805. The notification includes address information to establish a VoIP session with the caller (e.g., to enable the hybrid wireless handset 145 to contact the IP system 130). The notification includes information identifying the hybrid wireless handset 145, such as a telephone number, and includes information identifying the IP system 130, such as an IP address. As discussed above, the notification need not be for establishing a VoIP session.

The IP system 130 sends the notification to the phone network 110 through the IP network 105, block 810. The phone network 110 sends the notification to the hybrid wireless handset 145 through the phone base station 140 using a wireless phone connection, block 815. The hybrid wireless handset 145 extracts the address information from the notification and builds a connection reply, including address information so the IP system 130 can establish a connection to the hybrid wireless handset 145. The hybrid wireless handset 145 opens a wireless IP connection to the IP base station 125 and sends the connection reply to the IP network 105 through the IP base station 125, block 820. The IP network 105 sends the connection reply to the IP system 130, block 825. The IP system 130 receives the connection reply from the server 115 and establishes a connection to the hybrid wireless handset 145 through the IP network 105, block 830. The IP system 130 and the hybrid wireless handset 145 are now connected through the IP network 105 (the IP system 130 has a wire connection to the IP network 105 through server 115, and the hybrid wireless handset 145 has a Wi-Fi connection to the IP network 105 through IP base station 125).

The various implementations of the invention are realized in electronic hardware, computer software, or combinations of these technologies. Some implementations include one or more computer programs executed by a programmable processor or computer. For example, referring to FIG. 2, in one implementation, the MSM 205 and the IP modem 210 include one or more programmable processors. The communication networks 105, 110 shown in FIG. 1 include one or more computers to support the networks. In general, each computer includes one or more processors, one or more data-storage components (e.g., volatile or non-volatile memory modules and persistent optical and magnetic storage devices, such as hard and floppy disk drives, CD-ROM drives, and magnetic tape drives), one or more input devices (e.g., mice and keyboards), and one or more output devices (e.g., display consoles and printers).

The computer programs include executable code that is usually stored in a persistent storage medium and then copied into memory at run-time. The processor executes the code by retrieving program instructions from memory in a prescribed order. When executing the program code, the computer receives data from the input and/or storage devices, performs operations on the data, and then delivers the resulting data to the output and/or storage devices.

Various illustrative implementations of the present invention have been described. However, one of ordinary skill in the art will see that additional implementations are also possible and within the scope of the present invention. For example, while the above description focuses on implementations using Wi-Fi, other wireless IP or WLAN interfaces can be used in other implementations, such as any type of 802.11 interface. Similarly, various telephone air interfaces other than CDMA can also be used in other implementations, such as TDMA, or GSM. In another alternative implementation, rather than using a hybrid wireless handset, a different form of hybrid wireless system is used, such as a hybrid wireless modem card or peripheral device for a PDA, or for a laptop or desktop computer system.

Accordingly, the present invention is not limited to only those implementations described above.

What is claimed is:

1. A method of establishing a connection to a hybrid receiver, comprising:
sending a connection request to a first communication network according to a first communication protocol, wherein the connection request includes sender address information to establish a connection using a second communication protocol; and
receiving a connection reply from a second communication network according to the second communication protocol and the sender address information.

2. The method of claim 1, further comprising:
sending a connection notification from the first communication network to the second communication network.

3. The method of claim 2, wherein:
said connection notification is a text message.

4. The method of claim 2, wherein:
said connection notification is a circuit switched voice call request.

5. The method of claim 1, wherein:
a wireless handset performs said receiving a connection reply.

6. The method of claim 5, wherein:
said wireless handset includes a wireless telephony modem and a wireless IP modem.

7. The method of claim 6, wherein:
said wireless telephony modem and said wireless IP modem share a single radio interface including one antenna.

8. The method of claim 1, wherein:
a network server performs said sending a connection request.

9. The method of claim 1, wherein:
said first communication protocol is a wireless telephony protocol.

10. The method of claim 9, wherein:
said first communication protocol is a CDMA protocol.

11. The method of claim 1, wherein:
said second communication protocol is a wireless IP protocol.

12. The method of claim 11, wherein:
said second communication protocol is a protocol according to IEEE 802.11.

13. A method of establishing a connection to a hybrid receiver, comprising:
receiving a connection notification from a first communication network according to a first communication protocol, wherein the connection notification includes sender address information to establish a connection using a second communication protocol; and
sending a connection reply to a second communication network according to the second communication protocol and the sender address information.

14. The method of claim 13, wherein:
a wireless handset performs said receiving a connection notification and said sending a connection reply.

15. The method of claim 14, wherein:
said wireless handset includes a wireless telephony modem and a wireless IP modem.

16. The method of claim 15, wherein:
said wireless telephony modem and said wireless IP modem share a single radio interface including one antenna.

17. The method of claim 13, wherein:
said first communication protocol is a wireless telephony protocol.

18. The method of claim 17, wherein:
said first communication protocol is a CDMA protocol.

19. The method of claim 13, wherein:
said second communication protocol is a wireless IP protocol.

20. The method of claim 19, wherein:
said second communication protocol is a protocol according to IEEE 802.11.

21. The method of claim 13, wherein:
said connection notification is a text message.

22. The method of claim 13, wherein:
said connection notification is a circuit switched voice call request.

23. A system for establishing a connection to a hybrid receiver, comprising:
means for sending a connection request to a first communication network according to a first communication protocol, wherein the connection request includes sender address information to establish a connection using a second communication protocol; and
means for receiving a connection reply from a second communication network according to the second communication protocol and the sender address information.

24. The system of claim 23, further comprising:
means for sending a connection notification from the first communication network to the second communication network.

25. The system of claim 23, wherein:
said means for sending a connection request and said means for receiving a connection reply include a wireless telephony modem and a wireless IP modem.

26. The system of claim 25, wherein:
said wireless telephony modem is a CDMA modem; and
said wireless IP modem is a modem operating according to IEEE 802.11.

27. The system of claim 25, wherein:
said wireless telephony modem and said wireless IP modem share a single radio interface including one antenna.

28. A hybrid receiver system, comprising:
means for receiving a connection notification from a first communication network according to a first communication protocol, wherein the connection notification includes sender address information to establish a connection using a second communication protocol; and
means for sending a connection reply to a second communication network according to the second communication protocol and the sender address information.

29. The system of claim 28, wherein:
said means for receiving a connection notification and said means for sending a connection reply include a wireless telephony modem and a wireless IP modem.

30. The system of claim 29, wherein:
said wireless telephony modem is a CDMA modem; and
said wireless IP modem is a modem operating according to IEEE 802.11.

31. The system of claim 29, wherein:
said wireless telephony modem and said wireless IP modem share a single radio interface including one antenna.

32. A hybrid wireless handset, comprising:
a radio interface including an antenna;
a wireless telephony modem connected to said radio interface;
a wireless IP modem connected to said wireless telephony modem and to said radio interface;
an audio interface connected to said wireless telephony modem and to said wireless IP modem; and
a user interface connected to said wireless telephony modem and to said wireless IP modem;
wherein when said wireless telephony modem receives a connection notification from a first communication network, said wireless IP modem sends a connection reply to a second communication network.

33. The handset of claim 32, wherein:
said wireless telephony modem is a CDMA modem; and
said wireless IP modem is a modem operating according to IEEE 802.11.

34. The handset of claim 32, wherein:
said connection notification is a text message.

35. The handset of claim 32, wherein:
said connection notification is a circuit switched voice call request.
